(19) United States
(12) Patent Application Publication
(10) Pub. No.: US 2008/0117727 A1
(43) Pub. Date: May 22, 2008

(54) HEAD, HEAD GIMBAL ASSEMBLY AND INFORMATION RECORDING APPARATUS

(76) Inventor: Takuya Matsumoto, Hachioji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/942,817

(22) Filed: Nov. 20, 2007

(30) Foreign Application Priority Data
Nov. 21, 2006 (JP) 2006-314175

(51) Int. Cl. G11B 7/00

(52) U.S. Cl. 369/44.14

(57) ABSTRACT

In an apparatus wherein a semiconductor laser, which is a light source, is disposed external to a flying slider and the semiconductor laser and the flying slider are coupled with each other using a waveguide, force applied from the waveguide to the flying slider is reduced to stabilize the levitation of the slider. A waveguide coupled with a semiconductor laser is fixed to a moving part disposed on a flying slider. The moving part is adapted to move in parallel with the traveling direction of light. A collimator lens is disposed on the moving part to change light exiting from the waveguide to parallel light. This parallel light is condensed by a lens fixed to the flying slider and is coupled with a waveguide in the flying slider.

### CLAIM OF PRIORITY

The present application claims priority from Japanese application JP 2006-314175 filed on Nov. 21, 2006, the content of which is hereby incorporated by reference into this application.

### BACKGROUND OF THE INVENTION

1. Field of the Invention

The present invention relates to a head having a flying slider for irradiating light onto a recording medium, a head gimbal assembly, and an information recording apparatus.

2. Background Art

In recent years, there has been proposed a thermally assisted magnetic recording method as a recording method for realizing a recording density of 1 Tb/in² or higher (H. Saga, H. Nemoto, H. Sukeda, and M Takahashi, Jpn. J. Appl. Phys. 38, Part 1, pp. 1839 (1999)). In a conventional magnetic recording apparatus, there arises the problem of loss of recorded information due to heat fluctuations for a recording density of 1 Tb/in² or higher. In order to prevent this problem from arising, the coercivity of a magnetic recording medium must be increased. However, excessively increasing the coercivity makes it impossible to form recording bits in the medium since there is a limit on the magnitude of magnetic fields that can be generated from a recording head. In order to solve this problem, in the thermally assisted magnetic recording method, the medium is heated with light at the moment of recording so that the coercivity thereof is decreased. This makes it possible to record information on high-coercivity media, thereby realizing a recoding density of 1 Tb/in² or higher.

In order for the above-described thermally assisted magnetic recording method to be effective, the vicinity of a magnetic pole for applying magnetic fields must be heated with light. For this purpose, a waveguide, for example, is formed beside the magnetic pole to guide the light of a semiconductor laser, which is a light source, to the vicinity of the magnetic pole's leading end. At this time, the semiconductor laser is either mounted on the flying slider or placed at the root of a suspension, from where light is guided to the flying slider using a waveguide, such as an optical fiber. (Kenji Kato et al., Jpn. J. Appl. Phys. Vol. 42, pp. 5102-5106 (2003)).

Non-Patent Document 1: Jpn. J. Appl. Phys. 38, Part 1, pp. 1839 (1999)
Non-Patent Document 2: Jpn. J. Appl. Phys. Vol. 42, pp. 5102-5106 (2003)

### SUMMARY OF THE INVENTION

If a semiconductor laser for light irradiation is placed on a flying slider in a thermally assisted magnetic recording apparatus, there is the possibility that the temperature of the flying slider rises due to heat generation from the semiconductor laser. Such a temperature rise causes the flying slider to become distorted, thereby degrading the stability of levitation. Note here that when writing data at high transfer rates, laser light must be modulated at high speeds. If the semiconductor laser is mounted on the flying slider, high-speed modulation becomes difficult to achieve since the distance from a modulation circuit to the semiconductor laser becomes longer. Accordingly, it is preferable from the above-described viewpoint that the semiconductor laser be placed external to the flying slider. However, if the semiconductor laser is placed external to the flying slider and light is guided by the waveguide from the semiconductor laser to the flying slider, the stress of the waveguide affects the flying slider and causes the levitation of the flying slider to become unstable.

It is therefore an object of the present invention to solve the problem of degradation in the stability of the flying slider caused by the stress of the waveguide when the semiconductor laser is placed external to the flying slider and light is guided to the flying slider using the waveguide.

A head in accordance with the present invention includes: a slider which floats above a moving medium and has a light-irradiating portion for irradiating light at the medium; a waveguide for transferring light from a light source to the light-irradiating portion of the slider; a waveguide movable mechanism for enabling the waveguide to move with respect to the slider with the exit optical axis of the waveguide kept parallel; a collimator lens disposed at a specific distance from the output end of the waveguide to collimate outgoing light from the waveguide; and an optical system for guiding collimated light from the collimator lens to the light-irradiating portion.

According to one aspect of the present invention, a waveguide is fixed to a moving part sliding over the upper surface of a flying slider. The moving part is adapted to slide in a direction parallel to the traveling direction of light (direction parallel to the axis of the waveguide). A collimator lens is mounted on the moving part and light exiting from the waveguide is changed to parallel light by the collimator lens. This parallel light, after being deflected toward a direction perpendicular to the upper surface of the slider by a mirror provided thereon, is condensed by a condensing lens disposed on the slider and is introduced to the waveguide in the slider.

As described above, if the waveguide is fixed to the moving part, stress is less likely to be applied to the flying slider even if it is applied to the waveguide. To explain this more specifically, it should be noted that the suspension becomes bent or elongates in a case where a disk vibrates vertically or a head is loaded or unloaded. At that time, force is applied to the flying slider in a direction in which the waveguide pushes the slider or in a direction in which the waveguide pulls the slider. As a result, the stable levitation of the flying slider is disturbed. In contrast, if the waveguide is fixed to the moving part, force applied to the slider is reduced even if it is applied in a direction in which the waveguide pushes or pulls the slider, since the waveguide can move with respect to the slider. Note that light exiting from the waveguide is always parallel light since the collimator lens is fixed to the moving part. Accordingly, it is possible to always converge outgoing light on the same position (center of the core of the waveguide in the slider) even if the moving part moves.

In one example, the moving part is fabricated by etching a substrate made of silicon or the like. At this time, a blade spring is used to couple between a base fixed onto the flying slider and the moving part. By coupling the base with the moving part in this way using the blade spring, it is possible to reduce axial fluctuations caused when the waveguide moves.

As a mirror for bending an optical path, a mirror created by etching part of the base or an element, such as a prism, which is independent of the base, may be used. When using a silicon substrate, the mirror may be fabricated by means of anisotropic etching. In this case, the mirror surface is angled 54.7 degrees with respect to the upper surface of the slider. For this reason, an element, such as a diffraction grating, for bending the optical path is inserted so that light enters perpendicular to the upper surface of the slider. The condensing lens may be disposed either between the mirror and the waveguide in the slider or between the collimator lens and the mirror.

The moving part may be separated from the base fixed onto the upper surface of the flying slider. In this case, a groove is formed on the base so that the moving part slides in the groove. Alternatively, the waveguide may be made to slide directly on the base, instead of fixing the waveguide to the moving part. When separating the moving part as described above, it is necessary to make the dimensions of the moving part and those of the groove on the base precisely agree with each other, in order to suppress fluctuations in the movement of the moving part. To that end, it is preferable that after forming a thin sacrificial film in the periphery of the moving part, a liquid material be flowed into the periphery, then the liquid material in the periphery be hardened by heating or light irradiation, and finally a groove be created by removing the sacrificial film. Alternatively, a grooved base may be fabricated first, then a sacrificial film may be formed inside the groove, then a moving part may be formed by flowing a liquid material into the groove, and finally the sacrificial film may be removed.

When mounting the above-described flying slider on a suspension, the waveguide connecting the flying slider with the semiconductor laser is disposed so as to be positioned at the center of the suspension. This is because force acts on the flying slider so as to rotate the slider in a direction parallel to a recording medium surface if the waveguide is positioned off the center. To that end, it is preferable that the waveguide be led through hollow components and the components be fixed to the center of the suspension. At this time, in order to reduce the possibility of the stress of the waveguide being applied to the slider, it is preferable that a slight gap is provided between the waveguide and each hollow component so that the waveguide moves with respect to the hollow component. In addition, the waveguide is preferably disposed so as to be parallel to the recording medium surface. If the waveguide is tilted with respect to the recording medium surface, force having a component perpendicular to the recording medium surface is applied from the waveguide to the flying slider, thereby destabilizing the levitation thereof. To this end, it is preferable that a distance “c” from the suspension to the center of a hollow portion virtually satisfies “c=a−b”, assuming that the distance from the suspension to the recording medium surface is “a” and the distance from the recording medium surface to the center of the waveguide when the waveguide is disposed so as to be level with the recording medium surface is “b”.

According to the present invention, in a thermally assisted magnetic recording apparatus wherein a semiconductor laser, which is a light source, is disposed external to a flying slider and the semiconductor laser and the flying slider are coupled with each other using a waveguide, it is possible to reduce force applied to the flying slider from the waveguide, thereby realizing the stable levitation of the flying slider.

### BRIEF DESCRIPTION OF THE DRAWINGS

FIG. 1 is a sectional side view illustrating a flying slider equipped with the waveguide coupler of the present invention;

FIG. 2 is a schematic view illustrating the waveguide coupler of the present invention, wherein FIG. 2A is a top view and FIG. 2B is a cross-sectional view;

FIG. 3 is a schematic view illustrating the waveguide coupler of the present invention, wherein FIG. 3A shows a case where force is applied in a direction in which a waveguide pushes the flying slider and FIG. 3B shows a case where force is applied in a direction in which the waveguide pulls the flying slider;

FIG. 4 is a perspective view wherein the waveguide coupler of the present invention is viewed from the air bearing surface side of the flying slider;

FIG. 5 is a sectional side view of the waveguide coupler wherein a mirror fabricated by anisotropically etching a silicon substrate is used;

FIG. 6 is a schematic view illustrating a case where a prism is used as a means for bending an optical path;

FIG. 7 is a sectional side view illustrating the waveguide coupler wherein a condensing lens is interposed between a collimator lens and a mirror;

FIG. 8 is a schematic view illustrating a case where a moving part and a base are separated from each other, wherein FIG. 8A is a top view and FIG. 8B is a cross-sectional view;

FIG. 9 is a schematic view illustrating a process of fabricating the waveguide coupler in which the moving part and the base are separated from each other, wherein FIG. 9A shows a step of forming a sacrificial film, FIG. 9B shows a step of forming the base and FIG. 9C shows a step of removing the sacrificial film;

FIG. 10 is a schematic view illustrating a case where the waveguide slides on the base, wherein FIG. 10A is a top view and FIG. 10B is a cross-sectional view;

FIG. 11 is a schematic view illustrating a case where the moving part moves in a direction vertical to the traveling direction of light;

FIG. 12 is a schematic view illustrating a head gimbal assembly in which the waveguide coupler of the present invention is used, wherein FIG. 11A is a schematic view when the assembly is viewed from the recording medium side, FIG. 12B is a side view and FIG. 12C is a cross-sectional view of a hollow component for fixing the waveguide;

FIG. 13 is a schematic view illustrating a configuration example wherein a mobile mechanism is used in the coupling portion of the semiconductor laser and the waveguide;

FIG. 14 is a schematic view illustrating a configuration example of a recording and reproducing apparatus; and

FIG. 15 is a schematic view illustrating an optical system for optical reproduction.

### DETAILED DESCRIPTION OF THE PREFERRED EMBODIMENTS

Hereinafter, embodiments of the present invention will be described with reference to the accompanying drawings. In the following description, a structure, wherein a waveguide for guiding light from a light source is optically coupled with the light-irradiating portion of a flying slider for irradiating the light at a recording medium with the waveguide kept mobile with respect to the flying slider, is referred to as a waveguide coupler.

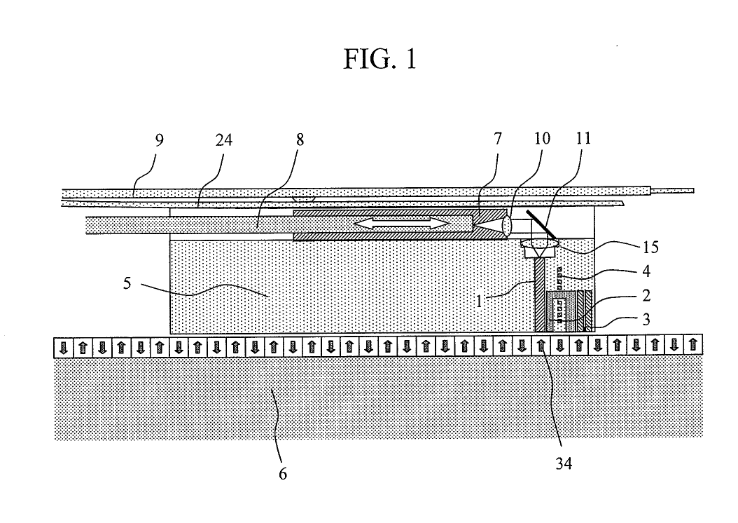

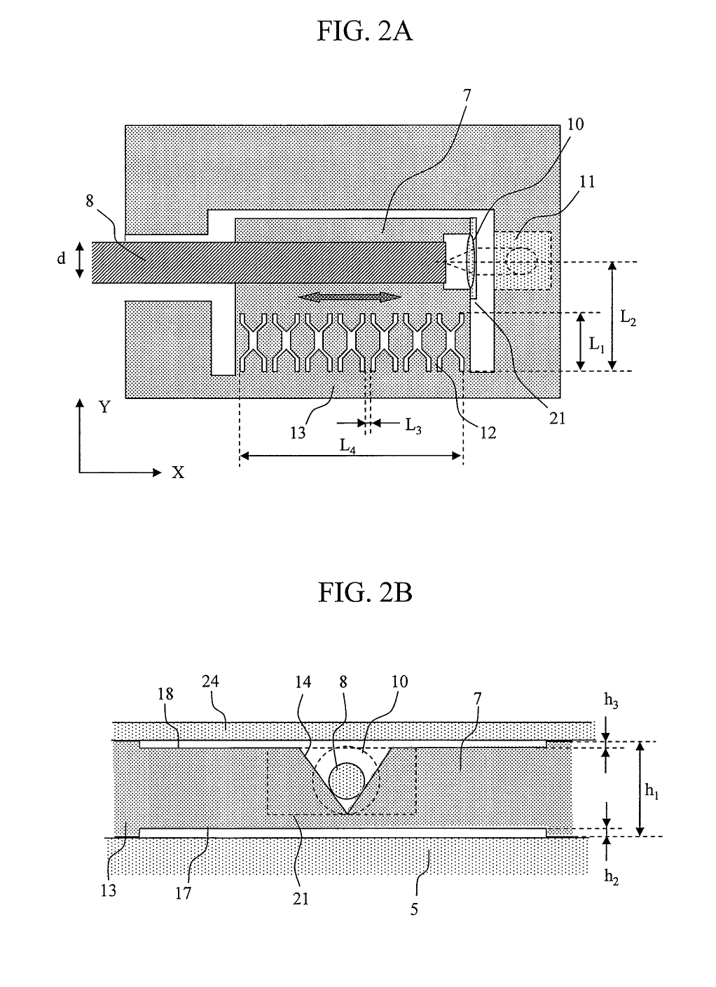

FIGS. 1 and 2 show a structural example of the waveguide coupler of the present invention. FIG. 1 is a side view of the flying slider as a whole, FIG. 2A is a top view of the waveguide coupler (figure as viewed from the side opposite to the air bearing surface side of the flying slider), and FIG. 2B is a cross-sectional view of the waveguide coupler. A coil 4 and a magnetic pole 2 for generating magnetic fields were formed in a flying slider 5, and a waveguide 1 for introducing light was formed beside the magnetic pole. Magnetic fields generated from the magnetic pole 2 were made to leak to the waveguide 1's side so that a light distribution and a magnetic field distribution at the edge face of the waveguide 1 overlapped with each other. A recording layer 34 present on the surface of a medium 6 was heated by light exiting from the waveguide 1 to decrease the coercivity of the recording layer 34 and, at that moment, the magnetization direction of the recording layer 34 was reversed by applying magnetic fields from the magnetic pole 2. For reproduction, there was used a magnetic reproducing sensor 3 composed of a magnetic reproducing element (Giant Magneto Resistive (GMR) element or Tunneling Magneto Resistive (TMR) element) placed in the vicinity of the magnetic pole 2.

The dimensions of the flying slider 5 were those of a femto slider (0.85 mm in length, 0.7 mm in width and 0.23 mm in thickness) and the material thereof was aluminum titanium carbide. A semiconductor laser was disposed external to the flying slider 5 and light from the semiconductor laser was guided using a waveguide 8. The waveguide 8 was fixed to a mount provided on the flying slider 5. At this time, the waveguide 8 was fixed to a moving part 7. The moving part 7 was adapted to move in a direction parallel to the traveling direction of light (direction X in FIG. 2). A substrate whereon a collimator lens 10 was formed was disposed at the output end of the waveguide 8 so that outgoing light from the waveguide 8 changed to parallel light. The collimator lens 10 was formed on a side surface of the moving part 7 so that the relative position of the waveguide 8 and the collimator lens 10 was always kept constant. Light passing though the collimator lens 10 was made to turn back at a reflecting mirror 11 by a condensing lens 15 disposed on the flying slider 5, and was coupled with the waveguide 1 formed beside the magnetic pole.

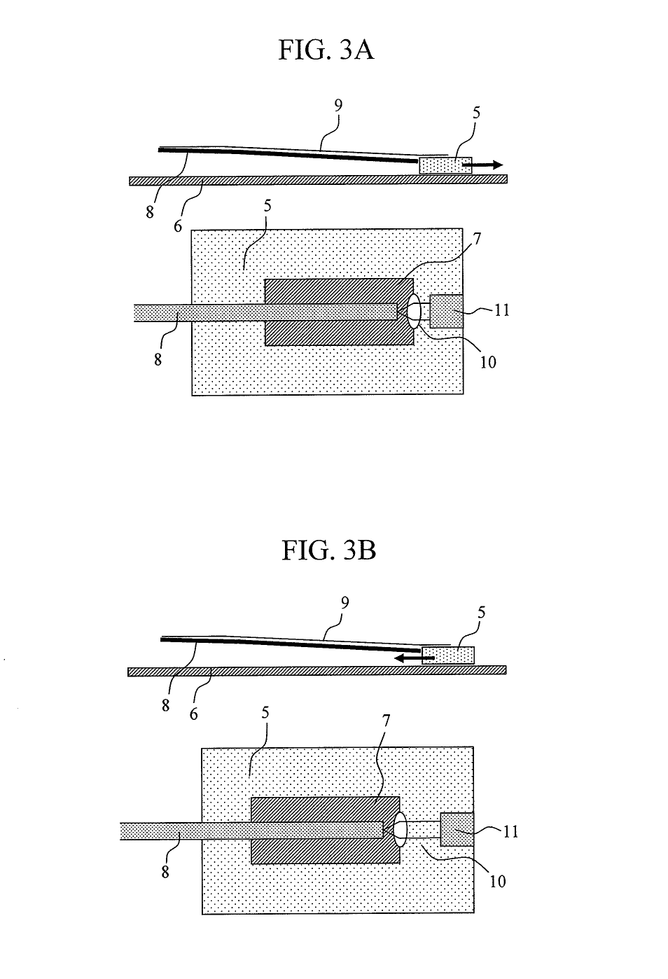

As described above, if the waveguide 8 is fixed to the moving part 7 movable with respect to the flying slider 5, stress is less likely to be applied to the flying slider 5 even if it is applied to the waveguide 8. To explain this more specifically, it should be noted that a suspension 9 becomes bent or elongates in a case where the recording medium 6 vibrates vertically or a head is loaded or unloaded. At that time, force is applied to the flying slider 5 in a direction in which the waveguide 8 pushes the flying slider 5 (FIG. 3A) or in a direction in which the waveguide 8 pulls the flying slider 5 (FIG. 3B), as shown in FIG. 3. As a result, the stable levitation of the flying slider is disturbed. In contrast, if the waveguide 8 is fixed to the moving part 7, force applied to the flying slider 5 is reduced since the moving part 7 moves in a direction opposite to the direction in which the waveguide 8 moves when, for example, force is applied in a such a manner that the waveguide 8 pushes the flying slider 5, as shown in FIG. 3A. Likewise, when force is applied in a direction in which the waveguide 8 pulls the flying slider 5, as shown in FIG. 3B, force applied to the flying slider 5 is reduced since the moving part 7 moves in a direction opposite to the direction in which the waveguide 8 moves. Note that light exiting from the waveguide 8 is always parallel light since the collimator lens 10 is fixed to the moving part 7. Accordingly, outgoing light always converges on the same position (center of the core of the waveguide 1 in the flying slider) even if the moving part 7 moves.

In the present embodiment, the moving part 7 to which the waveguide 8 was fixed and a portion (base) 13 to be fixed to the flying slider 5 were fabricated by etching a silicon substrate. A blade spring 12 was used to connect between the moving part 7 and the base 13 so that as the result of the blade spring 12 being bent, the moving part 7 moved in a direction parallel to the traveling direction of light. By utilizing the blade spring 12 as described above, it is possible to reduce the axial fluctuation of the waveguide 8 caused when it moves. The length L₁ of the blade spring 12 was 100 μm, L₄ was 300 μm, the width L₃ of a flexural part was 10 μm, and the distance L₂ from the root of the blade spring 12 to the center of the waveguide 8 was 200 μm. Since the optimum values of these dimensions vary depending on the dimensions and the material of the waveguide 8, it is preferable that adjustments be made while taking into consideration mechanical characteristics (e.g., resonant frequency). The thickness h1 of the base 13 was 100 μm. The upper and lower surfaces of the moving part 7 were trimmed so as not to come into contact with the flexure portion 24 of the suspension 9 and the flying slider 5. The depths of trimming were defined as h₃=2 μm and h₂=2 μm, respectively, for the upper and lower surfaces. As the waveguide 8, an optical fiber made of glass was used. The diameter (“d” in FIG. 2) of the clad part of the optical fiber was 15 μm. A V groove 14 was formed on the upper surface of the moving part 7 so that the center of the waveguide 8 was always placed in a specific position and the waveguide 8 was fixed in the groove. This V groove was created by means of the anisotropic etching of silicon. In the present embodiment, although this V groove was created on the upper surface of the moving part 7, the V groove may be created on the lower surface thereof. In addition, a polymer waveguide may be used instead of using an optical fiber as the waveguide 8. Since the shape of the waveguide is either square or rectangular in this case, the groove should be created so that the depth thereof is uniform (bottom surface thereof is flat). Although a silicon substrate was used as the substrate in the above-described embodiment, a substrate made of another material, such as SiO₂, aluminum titanium carbide or the like, may be used. In addition, the flying slider 5 and the base 13 may be fabricated so as to be integral with each other.

The collimator lens 10 to be disposed at the outlet of the waveguide 8 was a spherical lens, the diameter of which was 90 μm, and the numerical aperture of which was 0.3. The numerical aperture of the lens is preferably selected in conformity with the numerical aperture of the waveguide 8. This lens 10 was fabricated on a thin glass plate 21 and the glass plate 21 was attached to the side surface of the moving part 7. The position of the collimator lens 10 or the waveguide 8 was adjusted so that light passing through the collimator lens 10 perfectly changed to parallel light. In the present embodiment, although a spherical lens was used as the collimator lens 10, an aspherical lens, a Fresnel lens, or a distributed refraction index lens may be used instead. Alternatively, the collimator lens 10 may be a semispherical lens and may be directly attached to the output end of the waveguide 8.

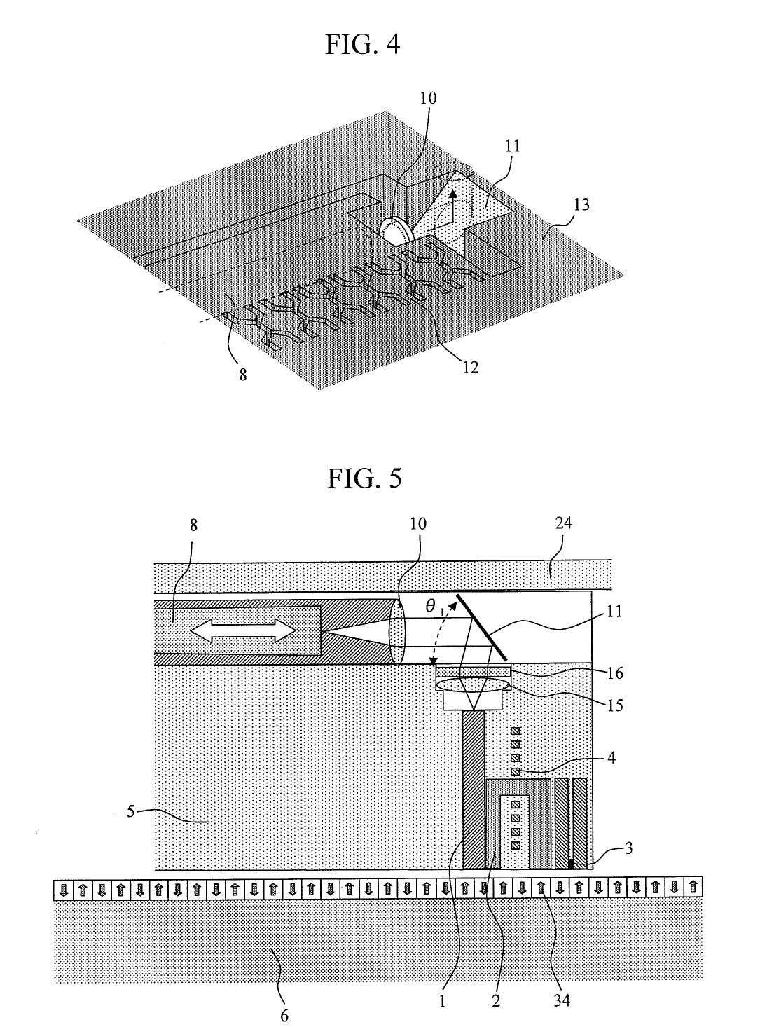

The mirror 11 for deflecting light passing through the collimator lens 10 was fabricated by diagonally trimming part of the base 13 and coating the trimmed part with a metallic reflection coating made of aluminum, silver, gold or the like, or with a dielectric multilayer, as shown in FIG. 4. In the present embodiment, although the moving part 7, the base 13 and the mirror 11 were fabricated so as to be integral with one another, the mirror 11 may be disposed independently. For example, a prism may be used as the mirror and may be disposed beside the collimator lens 10.

The diameter of the condensing lens 15 for coupling light deflected by the mirror 11 with the waveguide 1 in the flying slider 5 was 100 μm and the numerical aperture thereof was 0.3. This numerical aperture is preferably selected in conformity with the numerical aperture of the waveguide 8. As shown in FIG. 1, part of the upper surface of the flying slider 5 was trimmed and the condensing lens 15 was fitted into the trimmed part. The position of the condensing lens 15 was adjusted so that the focal point thereof was positioned at the center of the core of the waveguide 1 in the flying slider 5.

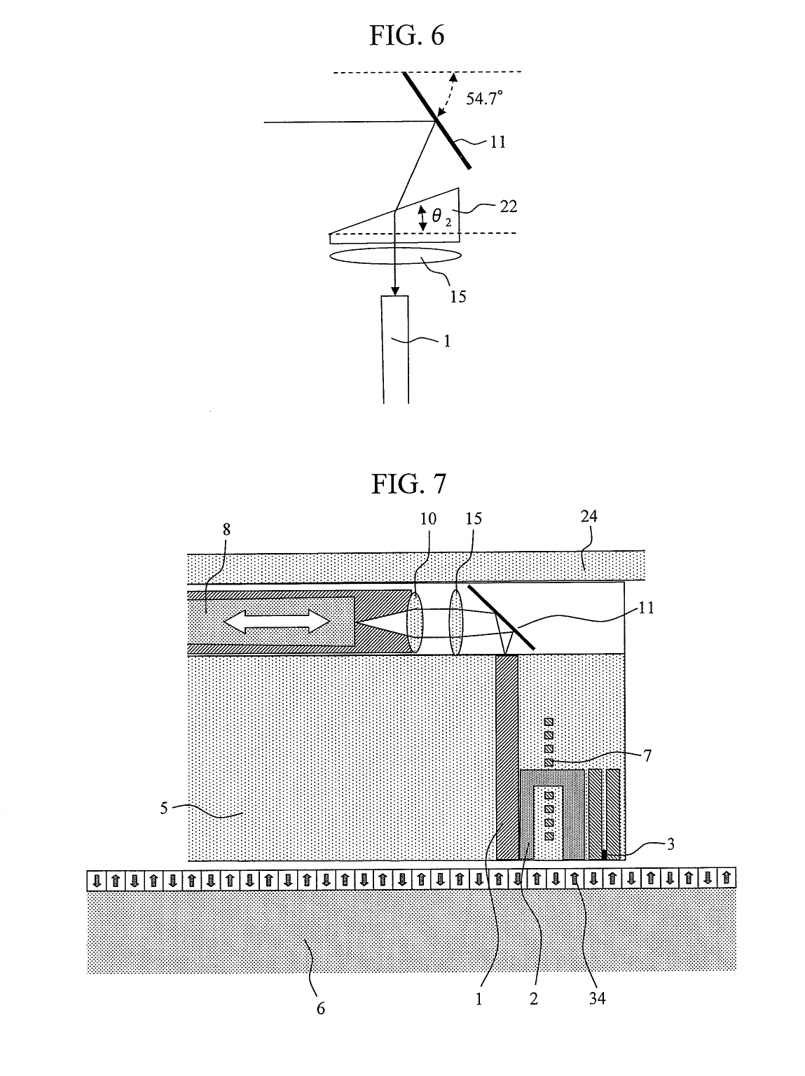

In the above-described embodiment, the mirror 11 was fabricated so that the surface thereof tilted 45 degrees with respect to the upper surface of the flying slider 5 to allow light reflected from the mirror 11 to perpendicularly enter the upper surface of the flying slider 5. Alternatively, the mirror 11 may be fabricated so as to tilt at an angle other than 45 degrees. For example, anisotropically etching a silicon substrate having a (100) surface causes the etched surface to tilt approximately 54.7 degrees with respect to the surface of the substrate. This (111) surface may be used as the mirror, as shown in FIG. 5 (mirror angle θ₁=54.7 degrees). In this case, reflected light enters obliquely with respect to the upper surface of the flying slider 5. Accordingly, in order to efficiently couple light with the waveguide 1 in the flying slider 5, the reflected light must be deflected so as to perpendicularly enter the upper surface of the flying slider 5. To this end, a diffraction grating 16 is preferably disposed above the condensing lens 15 as shown in FIG. 5, for example. Alternatively, the optical path may be bent using a prism 22 as shown in FIG. 6. The material of the prism 22 was glass and an angle θ₂ was approximately 33 degrees. In the embodiment shown in FIGS. 5 and 6, elements for bending the optical path, such as the diffraction grating and the prism, were disposed between the mirror 11 and the condensing lens 15. Alternatively, the elements may be disposed between the collimator lens 10 and the mirror 11.

In the above-described embodiment, the condensing lens 15 was disposed between the mirror 11 and the flying slider 5. Alternatively, the condensing lens 15 may be disposed between the collimator lens 10 and the mirror 11 (disposed in alignment with the collimator lens 10), as shown in FIG. 7. Disposing the condensing lens 15 in this way eliminates the need to trim the upper surface of the flying slider 5 at the portion thereof where the condensing lens 15 is disposed.

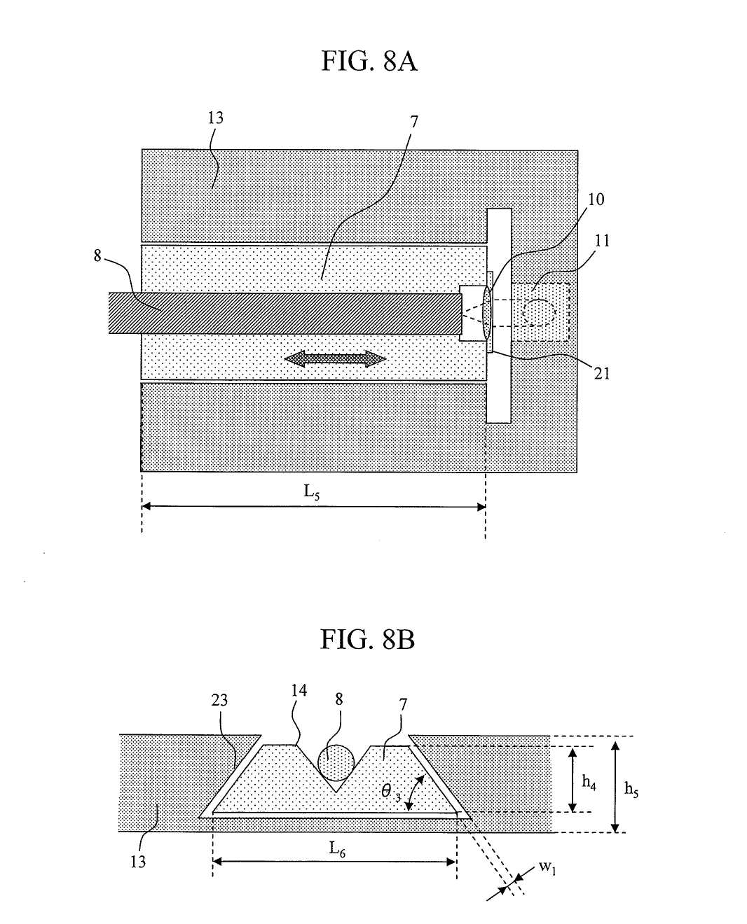

In the above-described embodiment, the blade spring 12 was used to connect between the moving part 7 and the base 13. Alternatively, the moving part 7 and the base 13 may be separated from each other so that the moving part 7 slides in a groove 23 provided in the base 13, as shown in FIG. 8. In the present embodiment, the groove 23 was formed in the base 13 in a direction parallel to the traveling direction of light and the moving part 7 was disposed in the groove. It is acceptable that the shape of the moving part 7 is a rectangular solid. In the case of a rectangular solid, however, the moving part 7 will disengage out of the groove 23 since there is a space in the upward direction of the moving part 7 (direction opposite to the air bearing surface thereof). Hence, in the present embodiment, the moving part 7 was shaped so that the width thereof tapered toward the upward direction thereof, as shown in FIG. 8B. The bottom-side length L₅ of the moving part 7 was 600 μm and the bottom-side width L₆ thereof was 200 μm. The angle θ₃ of the side walls of the moving part 7 was 54.7 degrees. The thickness h₅ of the base 13 was 100 μm and the thickness h₄ of the moving part 7 was 70 mm. The material of the moving part 7 was silicon and the side walls of the moving part 7 were sloped by means of anisotropic etching. The distance w₁ between the moving part 7 and the base 13 was 1 μm. A lubricating liquid may be provided between the moving part 7 and the base 13, in order to smoothen the slide of the moving part 7. Alternatively, the material of the moving part 7 or the base 13 may be changed to a material having less friction, such as Teflon, or a film made of a material having less friction, such as Teflon, may be formed on the surface of the moving part 7 or on the surface of the groove 23 provided in the base 13.

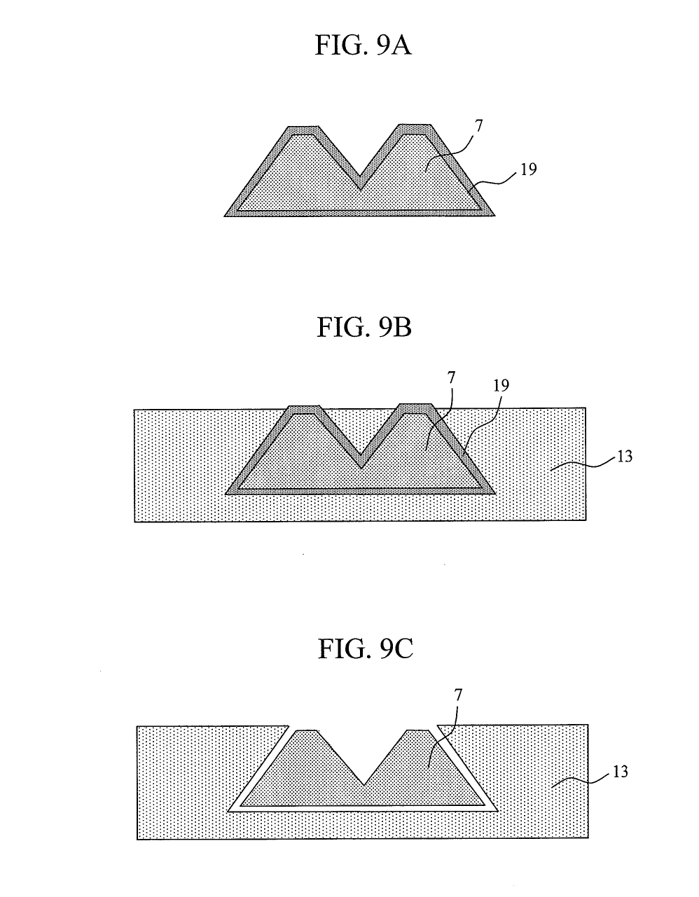

The moving part 7 and the base 13 may be fabricated separately and engaged with each other later. It is difficult, however, to make the dimensions of the moving part 7 and those of the groove on the base 13 agree with each other. If there are any mismatches in the dimensions, fluctuations occur in the movement of the moving part 7. Hence, the groove was created as shown in FIG. 9. First, after fabricating the moving part 7, the surface thereof was coated with a sacrificial film 18 (FIG. 9A). Next, a liquid thermoset resin was flowed into the periphery of the moving part 7 and was hardened by heating (FIG. 9B). Finally, the sacrificial film 19 was dissolved and removed (FIG. 9C). Aluminum was used for the sacrificial film 19 and an aluminum film was formed by sputtering. The thickness of the aluminum film was 1 μm. To remove the aluminum film, a compound liquid of phosphoric acid, nitric acid and acetic acid was used. The material of the sacrificial film 19 may be of any type as long as it is soluble in an etching solution or the like, or may be an organic film made of photoresist or the like. In this case, it is possible to remove the sacrificial film using an organic solvent, such as acetone. In the above-described embodiment, although a thermoset resin was used as the material of the base 13, an ultraviolet-cured resin or a thermoset organic material may be used instead. In addition, in the above-described embodiment, the moving part 7 was first fabricated and then the base 13 was fabricated in accordance therewith. Alternatively, the base 13 may be fabricated first and then the moving part 7 may be fabricated by flowing a liquid material into the base. In this case, the groove 23 for the sake of the moving part 7 is formed on the base 13 and a sacrificial film is formed on the surface of the groove. After flowing a liquid material onto the sacrificial film and then hardening the material, the sacrificial film is removed to separate the moving part 7 and the base 13 from each other.

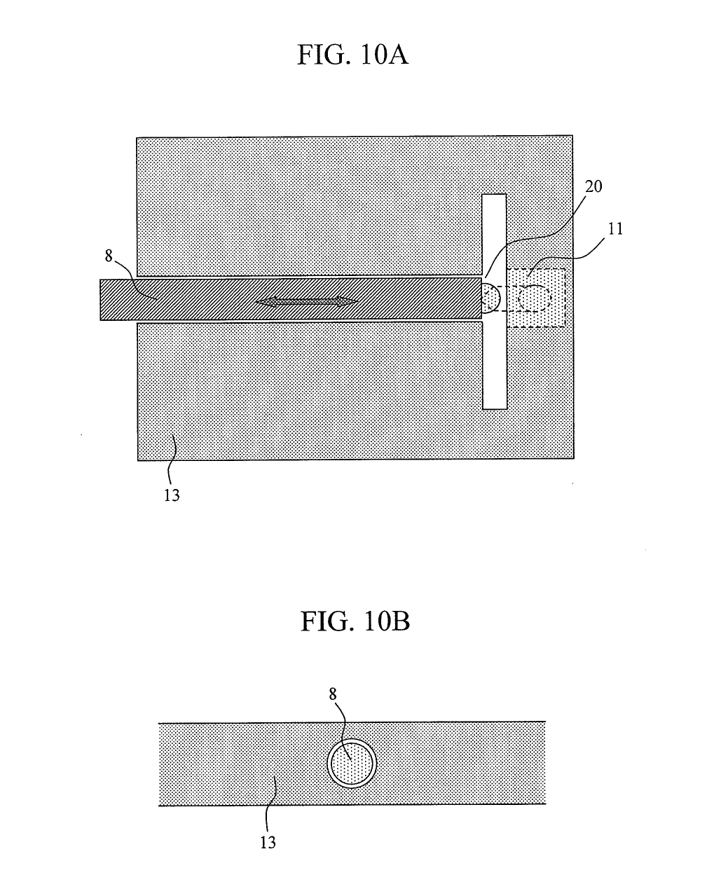

In the above-described embodiment, although the waveguide 8 was fixed to the moving part 7 and was slid, the waveguide 8 may be made to slide directly, as shown in FIG. 10. More specifically, the waveguide 8 is made to slide by forming in the base 13 a cavity for the waveguide 8 to pass through and leading the waveguide 8 thereinto. In this case, a collimator lens must be formed on the edge face of the waveguide 8 and, therefore, a semispherical lens 20 was disposed on the edge face of the waveguide 8 in the present embodiment.

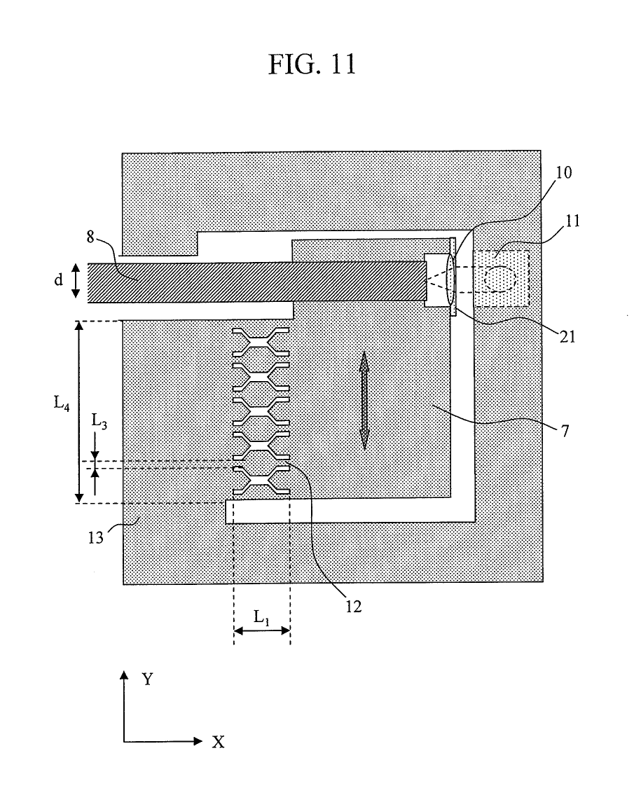

In the above-described embodiment, although the moving part 7 was adapted to move in a direction parallel to the traveling direction of light, the moving part may be adapted to move in a direction orthogonal to the traveling direction of light. If there is a large amount of vibration in a direction vertical to the traveling direction of light, it is possible to alleviate effects on levitation by allowing the moving part 7 to move in the vertical direction, as described above. FIG. 11 shows an embodiment wherein a blade spring is used. A moving part 7 for fixing a waveguide 8 and a portion (base) 13 to be fixed to a flying slider 5 were fabricated by etching a silicon substrate. A blade spring 12 was used to connect between the moving part 7 and the base 13 so that as the result of the blade spring 12 being bent, the moving part 7 moved in a direction parallel to the traveling direction of light. The length L₁ of the blade spring 12 was 100 μm, L₄ was 300 μm, and the width L₃ of a flexural part was 10 μm. A collimator lens 10 was placed on the moving part 7 so that light exiting from the waveguide 8 changed to parallel light. Light exiting from the collimator lens 10 was made to turn back at a mirror 11 and was condensed using the condensing lens 15 shown in FIG. 1. Since the light exiting from the collimator lens 10 at this point is parallel light, the position of the focal point of the condensing lens 15 does not change even if the moving part 7 moves in a direction vertical to the traveling direction of light.

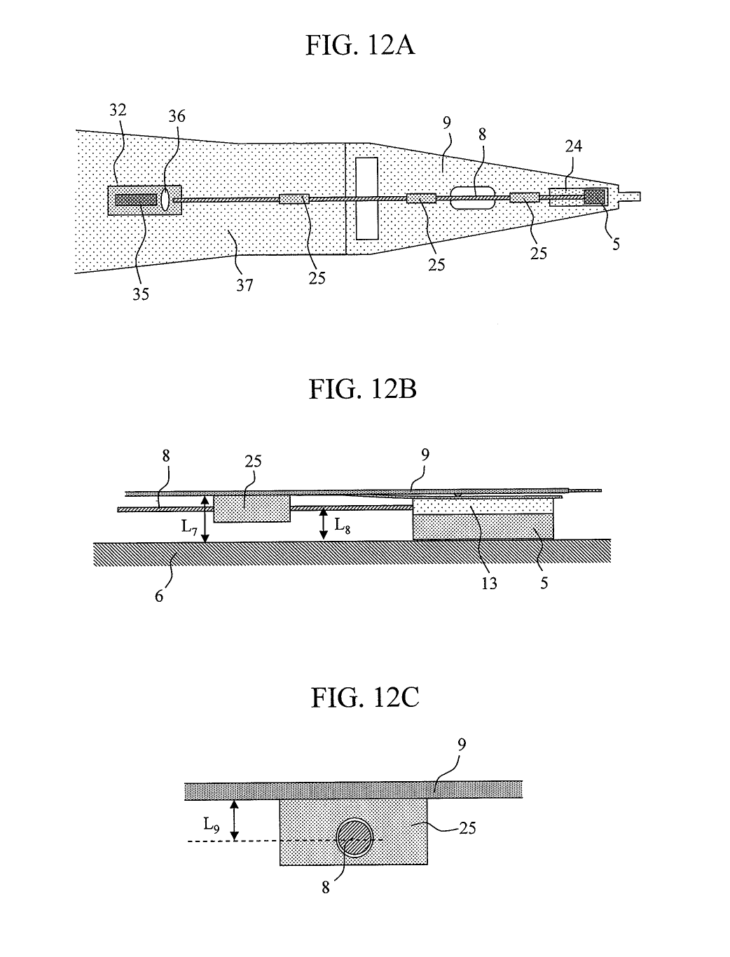

FIG. 12 shows a head gimbal assembly (HGA), wherein FIG. 12A is a schematic view in which a flying slider 5 is viewed from the air bearing surface side thereof and FIG. 12B is a side view. The base 13 of a waveguide coupler in accordance with the present invention was fixed to the flexural portion 24 of a suspension 9. The waveguide 8 was made to pass across the center of the suspension 9 in the width direction thereof. If the position of the waveguide 8 deviates from the center of the suspension 9 at this point, force acts on the flying slider 5 so as to rotate the slider in a direction parallel to a recording medium surface. In order to prevent this force from arising, it is preferable that the waveguide be always positioned at the center of the suspension 9. To that end, in the present embodiment, the waveguide 8 was led through hollow components 25 and the components were fixed to the center of the suspension 9 (see FIG. 12C). It is acceptable to fix the waveguide 8 and the hollow components 25 to each other. In order to reduce the possibility of the stress of the waveguide 8 being applied to the flying slider 5, however, a slight gap should preferably be provided between the waveguide 8 and each hollow component 25 so that the waveguide 8 moves in the axial direction with respect to the hollow components 25. In the present embodiment, the hollow components 25 were fabricated using a material having less friction, such as Teflon, so that the waveguide 8 was able to move easily. Note that the waveguide 8 is preferably disposed so as to be level with a recording medium surface (disposed so that a distance L₇ from the recording medium surface to the waveguide 8 is always kept constant). This is because force having a component perpendicular to the recording medium surface is applied from the waveguide 8 to the flying slider 5, thereby destabilizing the levitation thereof, if the waveguide 8 is disposed at a tilt with respect to the recording medium surface. In order to dispose the waveguide 8 as described above, it is recommendable that a distance L₉ from the suspension 9 to the center of each hollow portion of the hollow components 25 satisfies L₉=L₇−L₈, assuming that the distance from the suspension 9 to the recording medium surface is L₇ and the distance from the recording medium surface to the center of the waveguide 8 when the waveguide 8 is disposed so as to be level with the recording medium surface is L₈. Since it proved in the present embodiment that L₇=0.5 mm and L₈=0.28 mm, the waveguide 8 was disposed so as to satisfy L₈=0.22 mm.

In the present embodiment, a semiconductor laser 35 was used as the light source and this semiconductor laser 35 was placed on an arm 37, as shown in FIG. 12A. A coupling lens 36 was interposed between the semiconductor laser 35 and the waveguide 8 so that light from the semiconductor laser 35 was coupled with the waveguide 8. The semiconductor laser 35 and the coupling lens 36 were built into a low-profile package 32. Note that in the above-described embodiment, although the semiconductor laser 35 was disposed on the arm 37, the semiconductor laser may be disposed on the suspension 9 instead.

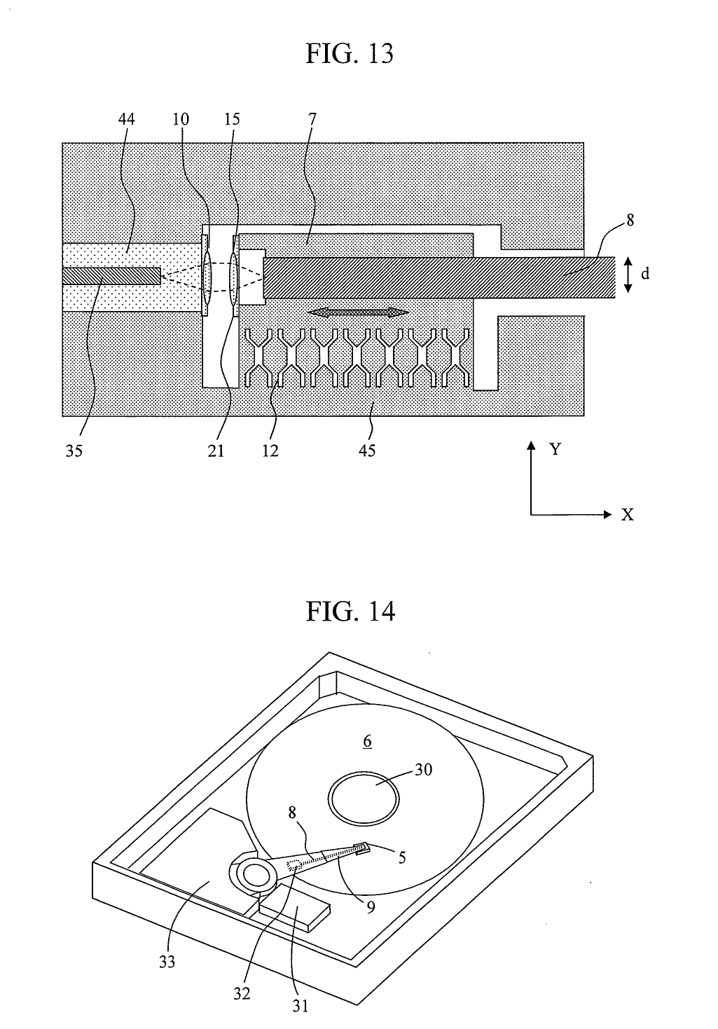

The waveguide coupler of the present invention may be used not only on the flying slider side but also in the coupling portion of the semiconductor laser 35 and the waveguide 8. In other words, the semiconductor laser 35 may be disposed in place of the waveguide 1 in the flying slider, as shown in FIG. 13. At this time, the semiconductor laser 35 is disposed so that the traveling direction of light exiting therefrom is parallel to the axis of the waveguide 8. By providing a mechanism for releasing force also on a side opposite to the waveguide 8, it is possible to further alleviate force applied to the flying slider 5 from the waveguide 8. In the present embodiment, a groove 44 to dispose the semiconductor laser 35 in was formed on a base 45 and the semiconductor laser 35 was disposed therein. Light exiting from the semiconductor laser 35, after being changed to parallel light by the collimator lens 10, was condensed by the condensing lens 15 and was coupled with the waveguide 8.

FIG. 14 is an overall view of a recording apparatus wherein the above-described waveguide coupler is used. The flying slider 5 was fixed to the suspension 9 and was moved by a voice coil motor 33. An air-bearing pad was formed on the surface of a head and the flying slider was levitated above a magnetic recording medium 6 with the amount of levitation no larger than 10 nm. The recording medium 6 was fixed to a motor-driven spindle 30 so as to spin thereon. A semiconductor laser was built in the low-profile package 32 disposed at the root of the arm. Light from the semiconductor laser was coupled with the waveguide 8 and was guided to the flying slider 5. At the moment of recording, magnetic fields were generated by a coil provided in the flying slider 5 and, at the same time, the semiconductor laser was made to emit light so that recording marks were formed. Data recorded on the recording medium 6 was reproduced with a magnetic reproducing element (GMR or TMR element) formed in the flying slider 5. The generation of recording waveforms and the processing of reproducing signals were carried out using a signal processing circuit 31.

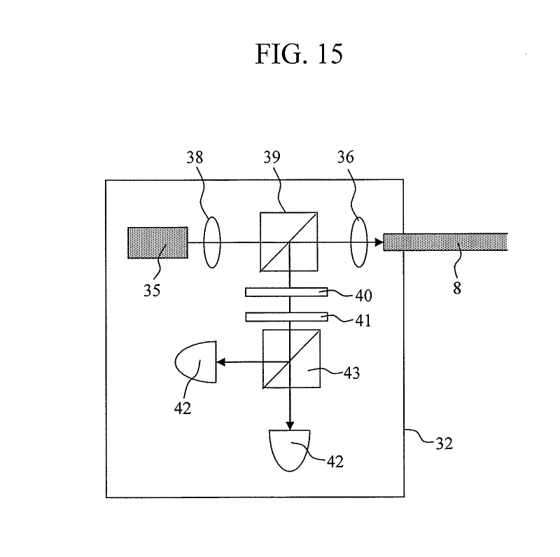

In the above-described embodiment, although a GMR or TMR element was used in order to reproduce recorded information, light may be used instead to reproduce the information. That is, light that hits against and bounces from recording bits transmits through the waveguide 1 in the flying slider and the waveguide 8 connecting the light source with the slider, toward a light source. The magnetization direction of recording bits was detected by detecting the polarization rotation of this return light from recording bits. For the detection noted above, an optical system shown in FIG. 15 was used. Light exiting from the semiconductor laser 35, after being changed to parallel light by a collimator lens 38, was condensed by a coupling lens 36 and was introduced to the waveguide 8. Return light from recording bits that exited from the waveguide 8, after being changed to parallel light by the coupling lens 36, was separated from incoming light by letting the return light pass through a beam splitter 39. The separated return light from recording bits was introduced to a quarter-wave plate 40 so as to be linearly polarized by adjusting the orientation of the quarter-wave plate 40 (light passing through the waveguide 8 may be elliptically polarized and, therefore, was changed back to linearly polarized light). Next, the return light was split into two beams of light orthogonal to each other by introducing the return light from recording bits to a half-wave plate 41 and a beam splitter 43. The magnetization direction of recording bits was read by detecting each light with a photodiode 42 and monitoring a difference in the strength of signals thus detected. At this time, the orientation of the half-wave plate 41 was adjusted so that the signal strength thereof was greatest. The above-mentioned optical system was formed within the package 32 and the package was disposed at the root of the arm, as shown in FIG. 12. Note that in the above-described embodiment, although a magnetic recording medium was used as the recording medium, other recording media, such as a phase-change medium, a photochromic medium or a coloring matter medium, may be used. In the case of a phase-change medium, for example, recorded information is read by detecting a change in the strength of return light from recording bits. In this case, the wave plates 41 and 42 and the polarizing beam splitter 43 shown in FIG. 15 are removed and the return light is directly detected with a single photodiode. If the recording medium employs a method of recording by light irradiation, as with a phase-change medium, a photochromic medium or a coloring matter medium, there is no need for a magnetic pole and a coil for generating magnetic fields. In this case, information can be recorded and reproduced by irradiating light at the recording medium.

What is claimed is:

1. A head comprising:
a slider which floats above a moving medium and has a light-irradiating portion for irradiating light at said medium;
a waveguide for transferring light from a light source to said light-irradiating portion of said slider;
a waveguide movable mechanism for enabling said waveguide to move with respect to said slider with the exit optical axis of said waveguide kept parallel;
a collimator lens disposed at a specific distance from the output end of said waveguide to collimate outgoing light from said waveguide; and
an optical system for guiding collimated light from said collimator lens to said light-irradiating portion.

2. The head according to claim 1, wherein said waveguide movable mechanism has a moving part fixed to said slider via a blade spring and the leading end of said waveguide and said collimator lens are fixed to said moving part.

3. The head according to claim 1, wherein said blade spring and said moving part are configured to be integral with each other using silicon.

4. The head according to claim 1, wherein said waveguide movable mechanism has a groove formed in said slider and a moving part which moves in engagement with said groove and the leading end of said waveguide and said collimator lens are fixed to said moving part.

5. The head according to claim 1, wherein said waveguide movable mechanism has a through hole provided in said slider so that said waveguide can slide inside said through hole and said collimator lens is fixed to the output end of said waveguide.

6. The head according to claim 1, wherein said optical system includes:
a second waveguide fixed to said slider;
a reflective element fixed to said slider to reflect parallel light exiting from said collimator lens toward the input end of said second waveguide; and
a condensing lens fixed to said slider to condense parallel light exiting from said collimator lens onto the input end of said second waveguide;
wherein light is irradiated from the output end of said second waveguide at said medium.

7. The head according to claim 1, further including a recording magnetic pole disposed adjacent to said light-irradiating portion to generate recording magnetic fields.

8. A head gimbal assembly comprising:
an arm;
a suspension connected to said arm;
a slider fixed to the flexure portion of said suspension and having a light-irradiating portion for irradiating light at a medium;
a light source fixed to said arm;
a waveguide for transferring light from said light source to said light-irradiating portion of said slider;
a waveguide movable mechanism for enabling said waveguide to move with respect to said slider with the exit optical axis of said waveguide kept parallel;
a collimator lens disposed at a specific distance from the output end of said waveguide to collimate outgoing light from said waveguide; and
an optical system for guiding collimated light from said collimator lens to said light-irradiating portion.

9. The head gimbal assembly according to claim 8, further including, at the center of said suspension in the width direction thereof, a holding member for holding said waveguide so that said waveguide can move in an axial direction.

10. The head gimbal assembly according to claim 8, wherein said waveguide movable mechanism has a moving part fixed to said slider via a blade spring and the leading end of said waveguide and said collimator lens are fixed to said moving part.

11. The head gimbal assembly according to claim 8, wherein said waveguide movable mechanism has a groove formed in said slider and a moving part which moves in engagement with said groove and the leading end of said waveguide and said collimator lens are fixed to said moving part.

12. The head gimbal assembly according to claim 8, wherein said waveguide movable mechanism has a through hole provided in said slider so that said waveguide can slide inside said through hole and said collimator lens is fixed to the output end of said waveguide.

13. The head gimbal assembly according to claim 8, wherein said optical system includes:
a second waveguide fixed to said slider;
a reflective element fixed to said slider to reflect parallel light exiting from said collimator lens toward the input end of said second waveguide; and
a condensing lens fixed to said slider to condense parallel light exiting from said collimator lens onto the input end of said second waveguide;
wherein light is irradiated from the output end of said second waveguide at said medium.

14. The head gimbal assembly according to claim 8, further including a recording magnetic pole disposed adjacent to said light-irradiating portion to generate recording magnetic fields.

15. An information recording apparatus comprising:
a recording medium;
a medium-driving portion for driving said recording medium;
an arm;
a suspension connected to said arm;
a slider fixed to the flexure portion of said suspension and having a light-irradiating portion for irradiating light at a medium;
a light source fixed to said arm;
a waveguide for transferring light from said light source to said light-irradiating portion of said slider;
a waveguide movable mechanism for enabling said waveguide to move with respect to said slider with the exit optical axis of said waveguide kept parallel;
a collimator lens disposed at a specific distance from the output end of said waveguide to collimate outgoing light from said waveguide;
an optical system for guiding collimated light from said collimator lens to said light-irradiating portion; and
an arm-driving portion for positioning said slider in a desired position of said recording medium by driving said arm.

16. The information recording apparatus according to claim 15, further including, at the center of said suspension in the width direction thereof, a holding member for holding said waveguide so that said waveguide can move in an axial direction.

17. The information recording apparatus according to claim 15, wherein said waveguide movable mechanism has a moving part fixed to said slider via a blade spring and the leading end of said waveguide and said collimator lens are fixed to said moving part.

18. The information recording apparatus according to claim 15, wherein said waveguide movable mechanism has a groove formed in said slider and a moving part which moves in engagement with said groove and the leading end of said waveguide and said collimator lens are fixed to said moving part.

19. The information recording apparatus according to claim 15, wherein said waveguide movable mechanism has a through hole provided in said slider so that said waveguide can slide inside said through hole and said collimator lens is fixed to the output end of said waveguide.

20. The information recording apparatus according to claim 15, wherein said optical system includes:
a second waveguide fixed to said slider;
a reflective element fixed to said slider to reflect parallel light exiting from said collimator lens toward the input end of said second waveguide; and
a condensing lens fixed to said slider to condense parallel light exiting from said collimator lens onto the input end of said second waveguide;
wherein light is irradiated from the output end of said second waveguide at said medium.
